(19) United States
(12) Patent Application Publication
(10) Pub. No.: US 2008/0031487 A1
(43) Pub. Date: Feb. 7, 2008

(54) Electro-Acoustic Transducer And A Method For Assembly Thereof

(76) Inventors: Kurt Sorensen, Horsens (DK); Martin H. Moller, Horsens (DK); Carit Laursen, Horsens (DK)

Correspondence Address: NIXON PEABODY, LLP, 161 N. CLARK ST., 48TH FLOOR, CHICAGO, IL, 60601-3213, US

(21) Appl. No.: 11/773,138

(22) Filed: Jul. 3, 2007

Related U.S. Application Data
(60) Provisional application No. 60/819,204, filed on Jul. 7, 2006.

(51) Int. Cl. H04R 1/00

(52) U.S. Cl. 381/396

(57) ABSTRACT

A miniature electro-acoustic transducer is provided which includes a magnetic circuit. The magnetic circuit includes a permanent magnet assembly adapted to generate a magnetic flux in an air gap, the permanent magnet assembly itself included first and second permanent magnets arranged on opposite sides of the air gap. A magnetically permeable outer housing portion forms an integral part of the magnetic circuit and a voice coil is positioned in the air gap, the voice coil being operatively connected to a diaphragm.

### CROSS-REFERENCE TO RELATED APPLICATIONS

This application claims the benefit of the U.S. Provisional Application 60/819,204, filed on Jul. 7, 2006, entitled “Electro-Acoustic Transducer And A Method For Assembly Thereof” and is hereby incorporated by reference in its entirety.

### FIELD OF THE INVENTION

The present invention relates to a miniature electro-acoustic transducer and, more particularly, a miniature electro-acoustic transducer comprising substantially concentrically arranged annular and centre magnets, wherein an outer transducer housing portion forms an integral part of a magnetic circuit of the electro-acoustic transducer. The present invention further relates to an improved automatic assembling method where the miniature electro-acoustic transducer according to the present invention can be assembled using a full automated assembly line.

### BACKGROUND OF THE INVENTION

U.S. Pat. No. 5,625,700 discloses a method for assembling an electro-acoustic transducer. The method suggested in U.S. Pat. No. 5,625,700 provides a simplified assembling process suitable for automatic assembling of electro-acoustic transducers. The method of U.S. Pat. No. 5,625,700 involves production steps including forming pole piece portions and forming a lead frame having a plurality of base forming areas thereon, wherein each of the base forming areas has lead terminals embedded therein, and wherein each of the base forming areas is provided by a synthetic resin on the lead frame by applying a moulding technique.

The base forming areas are moulded in a manner so that pole piece portions are embedded in the bases. A coil is then mounted on the pole piece portions. Following the mounting of the coil a support ring and a magnet surrounding the coil is provided. A diaphragm is attached to the support ring and the wire ends from the coil are connected to lead terminals, which are externally accessible. Finally, the electro-acoustic transducer is detached from the lead frame by cutting the lead terminals, and a housing/casing is attached to each of the base forming areas before the lead terminals are formed in a desired shape so that the final electro-acoustic transducers become suitable for surface mounting.

Thus, according to the method suggested in U.S. Pat. No. 5,625,700, lead terminals are integrated with the lead frame, whereas the base forming areas (outer housing portions of the electro-acoustic transducer) are moulded so as to embed a plurality of lead terminals in each base forming area.

It is a disadvantage of the method suggested in U.S. Pat. No. 5,625,700 that the base forming areas need to be manufactured separately, i.e. they do not form integral parts of the lead frame. Thus, when the lead frame with integrated lead terminals is provided an additional manufacturing process is required in order to form base forming areas which can be used as platforms for further assembling of electro-acoustic transducers.

### SUMMARY OF THE INVENTION

In accord with a first aspect of at least some of the present concepts, a miniature electro-acoustic transducer comprises a magnetic circuit including a permanent magnet assembly adapted to generate a magnetic flux in an air gap. The permanent magnet assembly comprises first and second permanent magnets arranged on opposite sides of the air gap. The miniature electro-acoustic transducer in accordance with this aspect also comprises a magnetically permeable outer housing portion forming an integral part of the magnetic circuit and a voice coil positioned in the air gap, the voice coil being operatively connected to a diaphragm. Further variants of this first aspect are described below.

The magnetically permeable outer housing portion may comprise an essentially planar structure extending in a plane being essentially parallel to a plane of extension of the diaphragm. An edge portion may surround the essentially plane structure, the edge portion comprising a recess to which the diaphragm is adapted to be attached.

The magnetically permeable outer housing portion may form an outer pole piece of the magnetic circuit. Thus, no separate outer pole piece is required in that this outer pole may be formed by a part of the housing of the miniature electro-acoustic transducer. The fact that a part of the housing forms an outer pole carries with it several advantages, the most important of these being that a separate component, here an outer pole piece, can be saved to yield a reduction in costs. Further, the assembling process of the electro-acoustic transducer is simplified, which makes the assembling process according to the present invention suitable for automatic production lines.

The magnetically permeable outer housing portion may comprise a through-hole or opening. An inner surface of this opening may form an outer boundary of the air gap. The opening may be manufactured in a punching process whereby the edges of the opening become well-defined and sharp. The edges of the opening may form the air gap in combination with the equally sharp edges of an associated centre pole piece. In this way the magnetic flux in the air gap becomes well-defined and intense without large stray fluxes. Thus, since the flux lines are concentrated in the air gap the available force from the magnetic circuit is enhanced.

The shape of the openings may, in principle, be arbitrary. However, according to a preferred embodiment, the opening is essentially circular in shape.

The first permanent magnet may comprise an annular permanent magnet having a first surface attached to the magnetically permeable outer housing portion. The first surface of the annular magnet may be attached to the outer housing portion by gluing. The magnetic circuit may further comprise a magnetically permeable yoke attached to a second surface of the annular permanent magnet, the second surface being substantially parallel to the first surface of the annular permanent magnet. The second permanent magnet may comprise a centre magnet substantially concentrically arranged with the annular magnet. The centre magnet may be arranged with a first surface attached to the magnetically permeable yoke. The magnetic circuit may in addition comprise a magnetically permeable centre pole piece substantially concentrically arranged with the annular magnet, the centre pole piece being attached to a second surface of the centre magnet, the second surface of the centre magnet being substantially parallel to the first surface of the centre magnet. In a preferred embodiment, the annular and centre magnets have similar heights whereby the centre pole piece becomes substantially concentrically aligned in the opening of the magnetically permeable outer housing portion. The air gap is formed between an essentially circular outer edge of the centre pole piece and a corresponding and essentially circular inner edge of the opening of the magnetically permeable outer housing portion.

One or more air flow passages may be provided in the magnetically permeable outer housing portion, the one or more air flow passages allowing air trapped below the diaphragm to escape to the exterior of the transducer.

The miniature electro-acoustic transducer may further comprise a first and a second contact arrangement for providing a first and a second electrical connection from the exterior of the transducer to the interior of the transducer. The first and second contact arrangements may comprise an electrically conducting resilient member and a U-shaped clamp. The electrically conducting resilient member of each contact arrangement may comprise a spring element. Each of the U-shaped clamps may form an exterior contact pad arranged to receive a spring element. Each of the U-shaped clamps may, in addition, form an interior contact pad arranged to receive a wire end from the voice coil.

The miniature electro-acoustic transducer may further comprise a cover having one or more sound outlet openings arranged therein. The cover may be attached to the magnetically permeable outer housing portion so as to form a complete transducer housing in combination therewith.

In a second aspect, the present invention relates to a component carrier for a magnetically permeable outer part of a transducer housing of an electro-acoustic transducer, the component carrier comprising a magnetically permeable outer part of a transducer housing and a frame supporting the magnetically permeable outer part. The frame has registration elements formed therein for registration of the component carrier with other component carriers. The component carrier also comprises struts attaching the magnetically permeable outer part to the frame, the struts holding the magnetically permeable outer part in a substantially fixed position spaced apart from the frame. Further variants of this second aspect are described below.

The magnetically permeable outer part may comprise an essentially planar structure surrounded by an edge portion.

The magnetically permeable outer part may, in principle, be any part contributing to forming a housing of a miniature electro-acoustic transducer. When arranged in the component carrier the magnetically permeable outer part of the transducer housing forms a platform or base for the further assembly of the miniature electro-acoustic transducer in an automatic assembling line. As described in more detail below, a plurality of component carriers may be combined to form a strip of component carriers, which is highly suitable for automatic assembling. The magnetically permeable outer part may be oriented in substantially the same plane as the frame.

The magnetically permeable outer part may comprise an essentially circular opening adapted to receive a voice coil in that an inner surface of the opening may form an outer boundary of an air gap in an assembled electro-acoustic transducer. The magnetically permeable outer part may comprise one or more alignment members extending from the magnetically permeable outer part, the one or more alignment members being adapted to secure proper alignment of a permanent magnet assembly relative to the essentially circular though-hole or opening. The one or more alignment members may comprise a part or parts, such as a bent or raised part or parts, of the magnetically permeable outer part. The permanent magnet assembly may be attached to the magnetically permeable outer part by gluing.

One or more air flow passages may be provided in the magnetically permeable outer part, the one or more air flow passages allowing air trapped below a diaphragm to escape to the exterior of an assembled electro-acoustic transducer.

In a third aspect, the present invention relates to a method of assembling an electro-acoustic transducer, the method including the steps of providing a component carrier comprising a magnetically permeable outer part of a transducer housing and a frame supporting the magnetically permeable outer part. The frame has registration elements formed therein for registration of the component carrier (e.g., with other component carriers). The component carrier further comprises struts attaching the magnetically permeable outer part to the frame, the struts holding the magnetically permeable outer part in a substantially fixed position spaced apart from the frame. Further variants of this third aspect are described below.

As noted above, the magnetically permeable outer part may, in principle, comprise any part contributing to forming a housing of a miniature electro-acoustic transducer. When arranged in the component carrier the magnetically permeable outer part of the transducer housing forms a platform or base for the further assembly of the miniature electro-acoustic transducer in an automatic assembling line. As previously mentioned, and as described in more detail below, a plurality of component carriers may be combined to form a strip of component carriers, which is highly suitable for automatic assembling. The magnetically permeable outer part may be oriented in substantially the same plane as the frame.

The magnetically permeable outer part of the transducer housing may comprise a first opening adapted to receive a voice coil in that an inner surface of the first opening may form an outer boundary of an air gap in an assembled electro-acoustic transducer. The magnetically permeable outer part may comprise one or more alignment members extending from the magnetically permeable outer part, the one or more alignment members being adapted to secure proper alignment of a permanent magnet assembly relative to the essentially circular though-going opening. The one or more alignment members may comprise a part or parts, such as a bent or raised part or parts, of the magnetically permeable outer part. The magnetically permeable outer part may further comprise second and third openings adapted to receive connection terminals.

The method according to this third aspect of the present invention may further comprise the step of positioning U-shaped connection elements in the second and third openings so that electrical connections are established through the openings, each of the U-shaped connection elements forming an interior and an exterior contact pad. The U-shaped connection elements may comprise a flex-print material. The method may further comprise the step of attaching an electrically conducting resilient member to each of the exterior contact pads.

The method according to this third aspect of the present invention may further comprise the step of providing a voice coil in the first opening of the magnetically permeable outer part of the transducer housing, and connecting wire ends of the voice coil to the interior contact pads of the U-shaped connection elements. Preferably, the voice coil is provided by positioning the voice coil in an essentially concentric manner in the first opening of the magnetically permeable outer part. In addition, the plane in which the voice coil primarily extends is essentially parallel to an average plane of extension of the magnetically permeable outer part.

The method may further comprise the step of providing a diaphragm and attaching the provided diaphragm to a recess of the magnetically permeable outer part of the transducer housing. In order for the voice coil to be able to displace the diaphragm in response to current passed through the voice the diaphragm may be attached to the voice coil, for example by gluing.

In order to form a complete transducer housing the method according to this aspect of the present invention may further comprise the step of providing a cover and attaching the cover to the recess of the magnetically permeable outer part of the transducer housing. The cover may be equipped with one or more sound outlet openings.

In order for the voice coil and diaphragm to produce a sound pressure the voice coil needs to be positioned in a magnetic flux. To comply with this, the method according to this aspect of the present invention may further comprise the step of providing a permanent magnet assembly and attaching the permanent magnet assembly to the magnetically permeable outer part of the transducer housing, for example, by gluing.

The magnet assembly may comprise an annular magnet and a centre magnet substantially concentrically arranged. The magnet assembly may further comprise a centre pole piece arranged on the centre magnet and a yoke forming a magnetic return path between the annular and the centre magnet.

The method may further comprise the step of testing at least one assembled electro-acoustic transducer by providing one or more test signals to the electrically conducting resilient members. Finally, the method may comprise the step of releasing the assembled electro-acoustic transducer from the frame.

As previously mentioned, and described in more details later, a plurality of component carriers may be combined to form a strip of component carriers which is highly suitable for automatic assembling. In case of a strip comprising a plurality of component carriers the above-mentioned various transducer components, such as connection elements, voice coils, diaphragms, covers etc., may be provided in bundles. Thus, in case a strip comprises ten components carriers, twenty connection elements are provided simultaneously. Similarly, ten voice coils are provided simultaneously to the strip of component carriers.

The above summary of the present invention is not intended to represent each embodiment, or every aspect, of the present invention. This is the purpose of the figures and the detailed description which follow.

It is an advantage of the present invention that the lead frame comprises integrated outer housing portions which can be directly used for further assembling of electro-acoustic transducers. Thus, according to the method suggested by the present invention a time consuming manufacturing step involving manufacturing of base forming areas can be completely avoided.

It is a further advantage of the present invention that the integrated outer housing portion forms an integral part of a magnetic circuit of the assembled electro-acoustic transducer.

Accordingly, one object of the present invention to provide a miniature electro-acoustic transducer suitable for being manufactured in an automatic assembly line, i.e. without using manual hand-assembly.

### BRIEF DESCRIPTION OF THE DRAWINGS

The present invention will now be explained in further details with reference to the accompanying drawings, wherein:

FIG. 1 shows components carriers for an outer housing portion of an electro-acoustic transducer, the component carrier forming a strip,

FIG. 2 shows the assembling of electrical contact terminals to an outer housing portion,

FIG. 3 shows the outer housing portion having electrical terminals attached thereto,

FIG. 4 shows the providing of a voice coil on a rod,

FIG. 5 shows the provided voice coil with wires electrically connected to the electrical terminals,

FIG. 6 shows the providing of a diaphragm,

FIG. 7 shows the how the diaphragm is mounted in a recess of the outer housing portion,

FIG. 8 shows the providing of a cover,

FIG. 9 shows the how the cover is mounted in a recess of the outer housing portion,

FIG. 10 shows a cross-sectional view of a motor suitable for being attached to the exterior of the outer housing portion,

FIG. 11 shows the providing of the motor of FIG. 10,

FIG. 12 shows a top view of the miniature electro-acoustic transducer including a motor,

FIG. 13 shows a bottom view of the miniature electro-acoustic transducer including a motor,

FIG. 14 shows a bottom view of an alternative embodiment of the miniature electro-acoustic transducer,

FIG. 15 shows a miniature electro-acoustic transducer freed from its connections to the component carrier,

FIG. 16 shows an exploded top view of a double transducer system,

FIG. 17 shows an exploded bottom view of a double transducer system, and

FIG. 18 shows an assembled double transducer system.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In its most general aspect, the present invention relates to a method for assembling electro-acoustic transducers using an automatic assembling line. In order to achieve this, a series of components carriers are interconnected to form a strip of component carriers in combination. Each component carrier comprises at least one transducer element. Thus, a plurality of interconnected component carriers forming a strip in combination comprises a plurality of identical transducer elements. Each of the component carriers comprises one or more alignment marks so that a given component carrier comprising a given transducer element can be aligned with another component carrier comprising another type of transducer element.

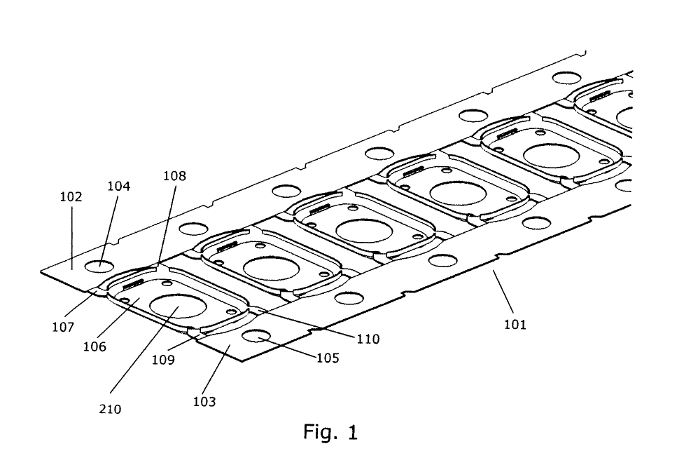

Referring now to FIG. 1, a strip 101 of interconnected component carriers is depicted. Each component carrier comprises a frame 102, 103 with alignment members 104, 105 arranged therein. The alignment members 104, 105 of FIG. 1 comprise through-holes or openings, but other implementations of the alignment members are also applicable.

The component carriers depicted in FIG. 1 each comprises a magnetically permeable outer housing portion 106 which is fixedly arranged relative to the frame 102, 103 via four struts 107, 108, 109, 110. The magnetically permeable outer housing portion 106 will form an outer housing portion of an assembled electro-acoustic transducer. As depicted in FIG. 1, the magnetically permeable outer housing portion 106 comprises an essentially planar structure surrounded by an edge portion to which the diaphragm is adapted to be attached. In an assembled miniature electro-acoustic transducer, the essentially planar structure of the magnetically permeable outer housing portion 106 will be oriented in a plane being essentially parallel to the diaphragm of the electro-acoustic transducer. Thus, the part of the magnetically permeable outer housing portion 106 which forms an integral part of the magnetic circuit will primarily guide the magnetic flux in a plane substantially parallel to the diaphragm.

A centrally positioned through-hole or opening 210 is provided in the magnetically permeable outer housing portion 106. This centrally positioned opening 210 is adapted to form an outer boundary of an air gap. The centrally positioned opening 210 is manufactured, in at least some aspects, by a conventional punching technique whereby the edges of the centrally positioned openings become very sharp and well-defined without rounded corners or edges. The sharp and well-defined edges of the centrally positioned opening 210 increase the flux density in the air gap. Other manufacturing methods (e.g., drilling) may alternatively be used, in isolation or in combination with finishing steps, to form the centrally positioned opening 210. Preferably, the components carriers are made of a ferromagnetic material.

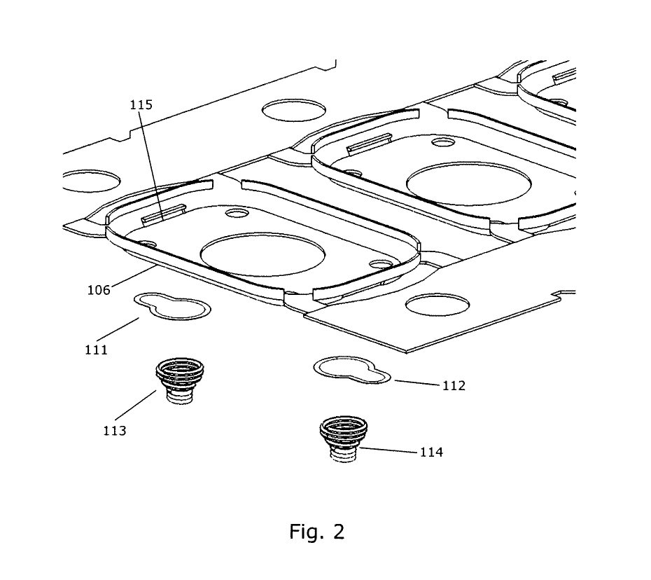

FIG. 2 shows a close up view of a component carrier comprising the magnetically permeable outer housing portion 106. A pair of flexible connection elements 111, 112 and a pair of spring elements 113, 114 are provided from beneath. Each of the flexible connection elements 111, 112 is adapted to be folded to form a U-shaped clamp. When U-shaped clamp 111 is inserted into opening 115 in the magnetically permeable outer housing portion 106, an electrically conducting path from the interior to the exterior of the magnetically permeable outer housing portion 106 is provided. Thus, in its folded state, and when positioned in its respective openings in the magnetically permeable outer housing portion 106, connection elements 111, 112 provide electrically conductive paths between the interior and the exterior of an assembled electro-acoustic transducer. The flexible connection elements 111, 112 are, in at least some aspects, made of a flex-print material having an electrically conductive path arranged on a surface thereof.

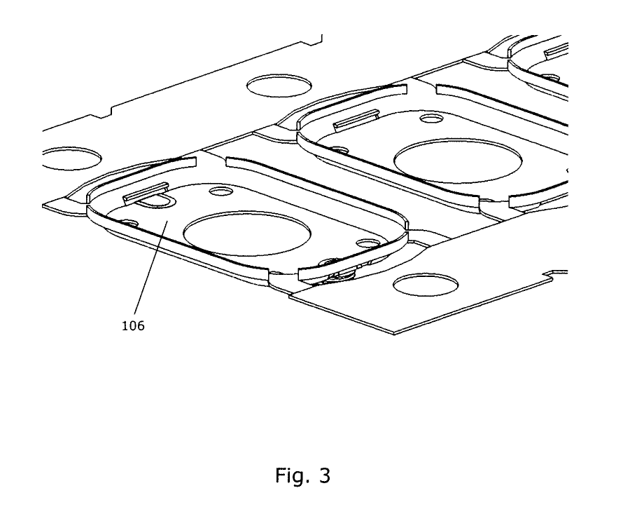

In order to provide electrical connections to the surroundings of the electro-acoustic transducer, a pair of electrically conducting spring elements 113, 114 are brought into contact with the electrically conducting paths of the connecting elements 111, 112. Electrical contact between connection elements and spring elements may be provided by soldering. FIG. 3 shows the magnetically permeable outer housing portion 106 with connection elements and spring elements attached thereto.

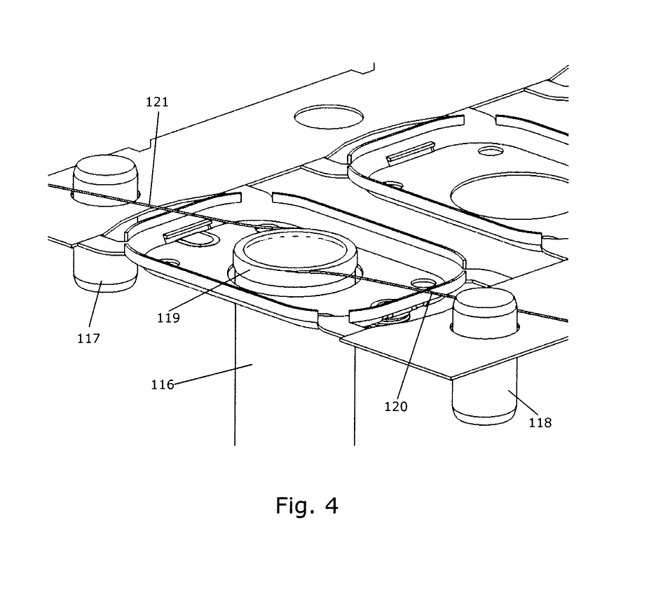

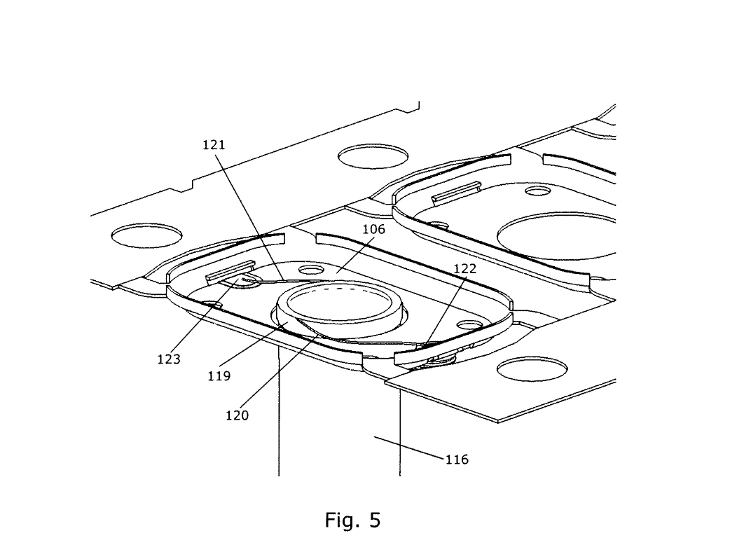

In FIG. 4, a centrally positioned rod 116 provides a voice coil 119 with connection leads 120, 121. The positioning of the connection leads 120, 121 is control by support rods 117, 118. In FIG. 5, the connection leads 120, 121 have been attached to interior terminals 122, 123, such as by thermo-compression, which are both electrically connected to respective ones of previously depicted spring elements 113, 114. Rod 116 keeps voice coil 119 in a fixed relationship with the magnetically permeable outer housing portion 106.

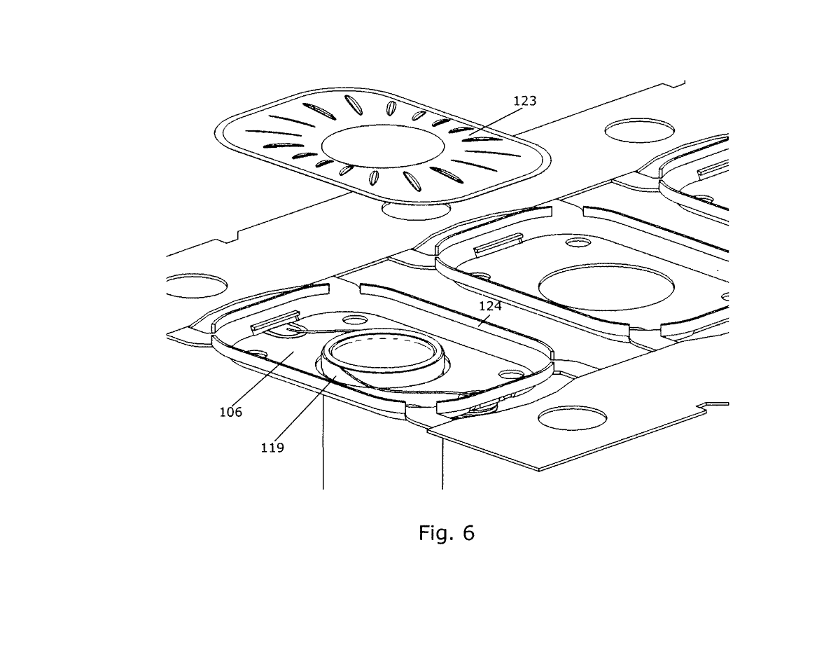

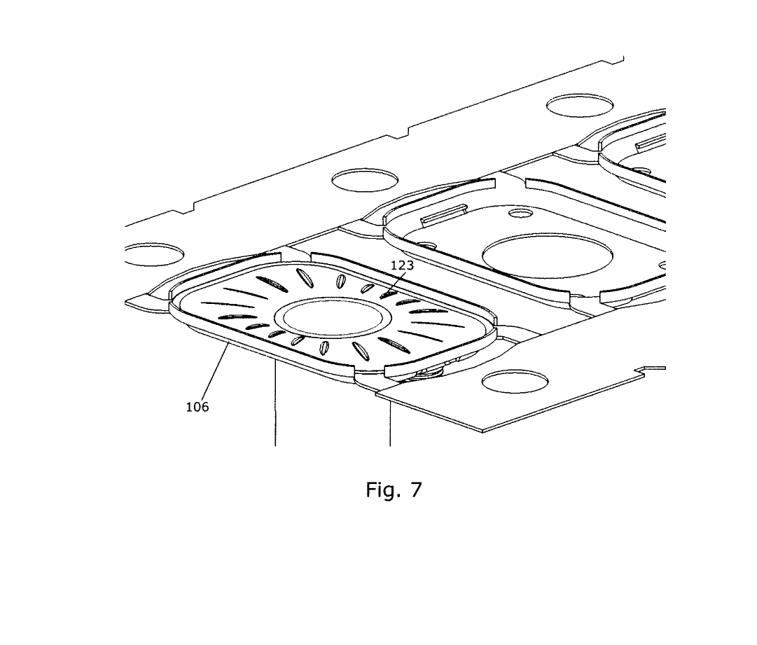

FIG. 6 shows attachment of diaphragm 123. Before bringing the diaphragm 123 in contact with the voice coil 119 and recess 124 of the magnetically permeable outer housing portion 106, glue is disposed on the voice coil 119 and/or the recess 124. Alternatively, glue may be disposed on the associated parts of the diaphragm 123. In FIG. 7, the diaphragm 123 has been glued to the magnetically permeable outer housing portion 106 and the voice coil, which is hidden below the diaphragm.

The diaphragm may comprise a polymer film having a thickness in the range 5-25 μm. The diaphragm may be a single-layer diaphragm, or it may be a multi-layer diaphragm where a second polymer film is attached to at least part of a bigger polymer film. By laminating a diaphragm with another diaphragm the stiffness of specific regions of the diaphragm may be significantly increased. The types of polymer films may be polyarylate (PAR), polyetherimide (PEI), polyrtheretherketone (PEEK), polyphenylene sulphide (PPS), polyethylenenapthalate (PEN), terephtalate (PET) or polycarbonate (PC).

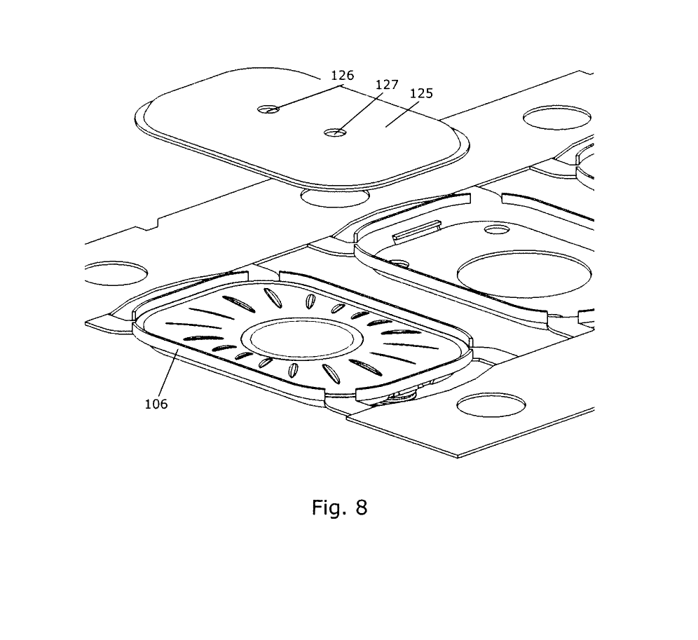

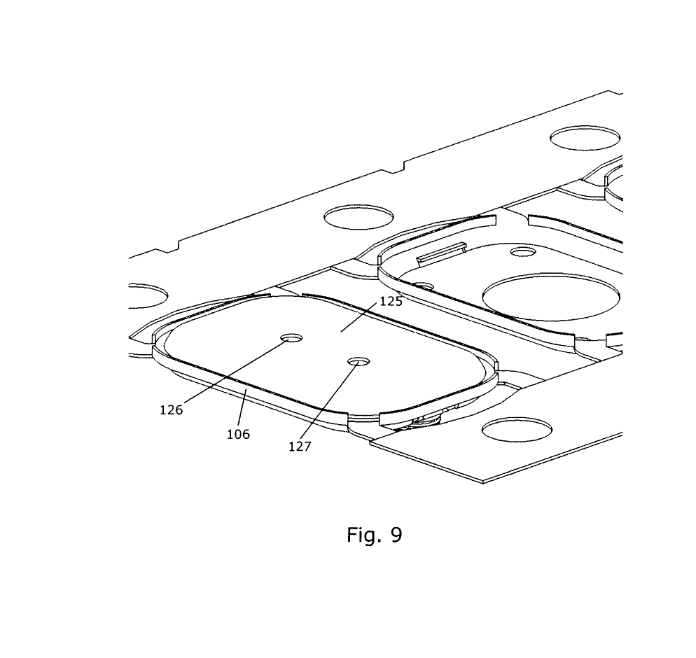

FIGS. 8 and 9 show how a cover 125 is provided and attached to the magnetically permeable outer housing portion 106. As seen in FIGS. 8 and 9, sound outlet openings 126, 127 are provided in the cover.

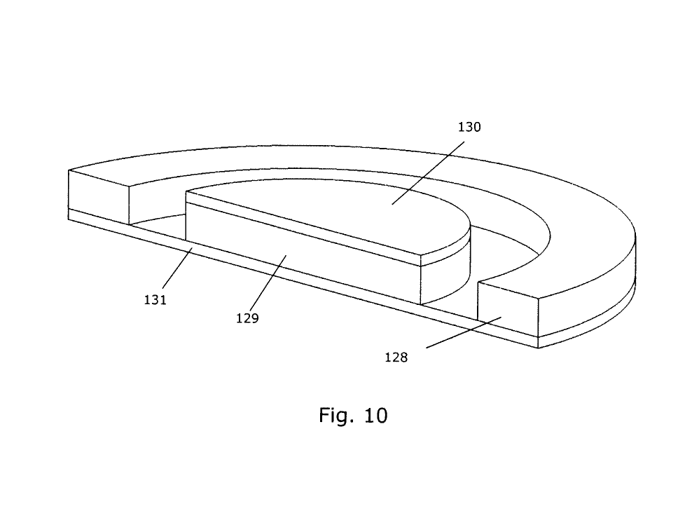

In order to be able to displace the diaphragm 123 in accordance with an electrical signal provided to the voice coil, the voice coil needs to be positioned in an air gap of a magnetic circuit. A cross-sectional view of the magnetic circuit applied in the present invention is depicted in FIG. 10. Obviously, other implementations of the magnetic circuit may also be applicable.

The magnetic circuit of FIG. 10 is constituted by an annular magnet 128, a centre magnet 129, a centre pole piece 130 and magnetically permeable yoke 131. The annular magnet and the centre magnet are permanent magnets. Part of the magnetically permeable outer housing portion 106 forms an outer pole piece which, in combination with the centre pole piece 130, forms an air gap adapted to receive the voice coil 119. The voice coil 119 is operatively connected to a displaceable diaphragm 123. When a time varying electrical drive signal is passed through the voice coil 119 the diaphragm 123 is displaced accordingly.

The centre magnet and/or the annular magnet may comprise, in at least some aspects, NdFeB compounds having a remanence flux density of at least 1.2 T, a coercive force of at least 1000 kA/m and an energy product of at least 300 kJ/m3. As an example, an NdFeB N44H may be applied.

The air gap may have a width in the range of 0.5-0.8 mm, such as around 0.6 mm. The average magnetic flux density in the air gap may be in the range of 0.3-1.5 T, such as in the range 0.5-1 T. Preferably, the voice coil is made of a wound copper wire or a wound Copper-Clad Aluminium (CCA) wire. In the case of a CCA wire, the copper content may be around 15%.

Suitable pole piece 130 materials are low carbon content steel materials such as, but not limited to, materials similar to Werkstoff-No. 1.0330 (St 2), 1.0333 (St 3), 1.0338 (St 4), all in accordance to DIN EN 10130.

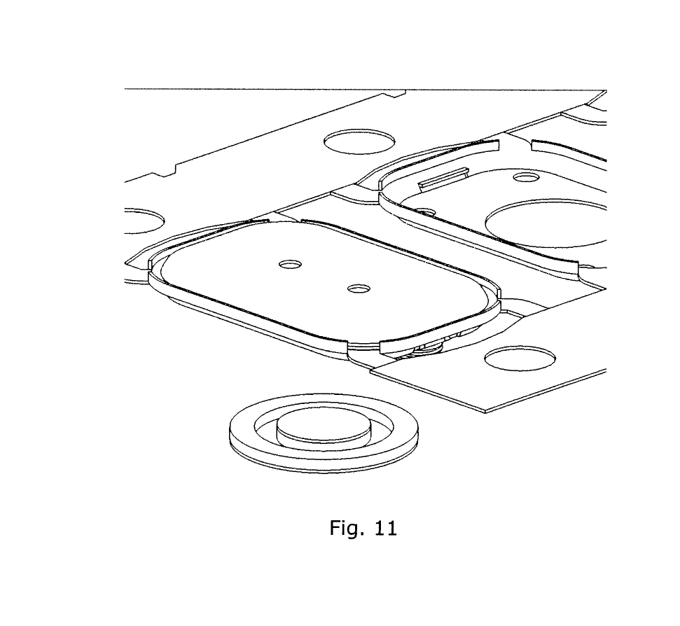

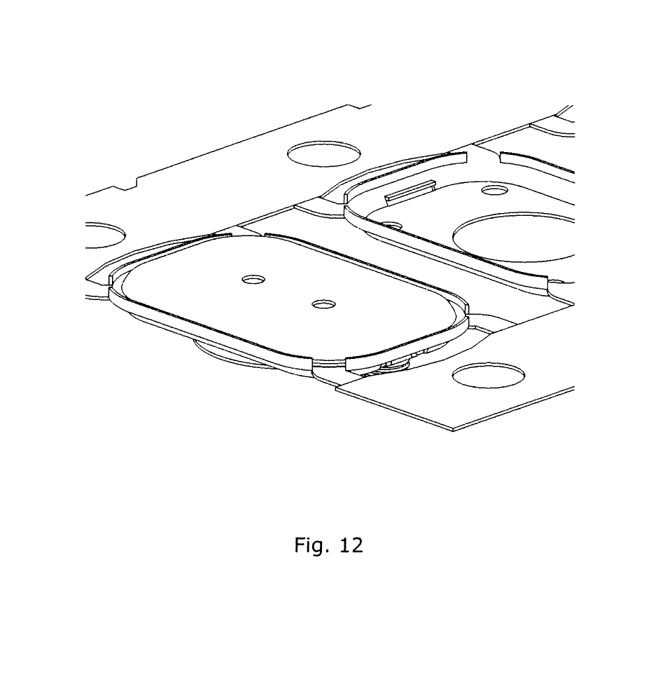

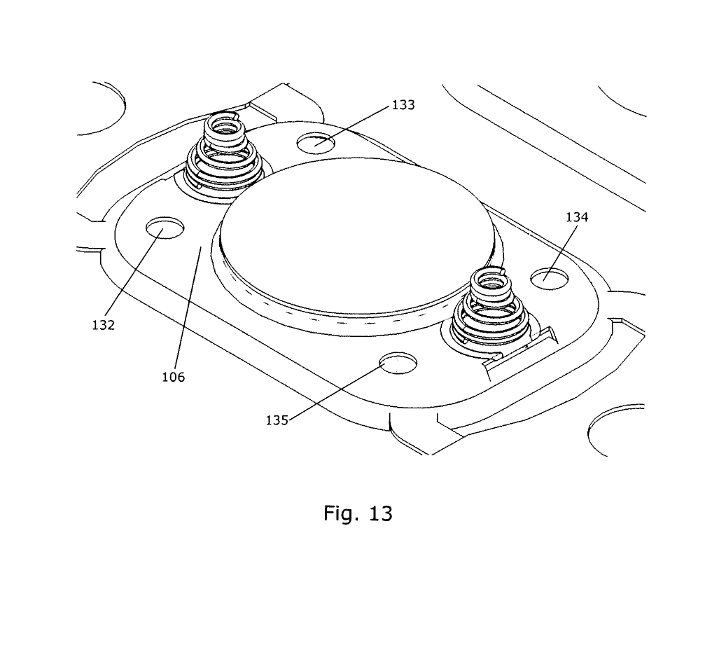

FIG. 11 shows a bottom view of the magnetic circuit attachment step. FIG. 12 shows a top view of the assembled electro-acoustic transducer 200, whereas FIG. 13 shows a bottom view of the same electro-acoustic transducer. The magnetic circuit is, in at least some aspects, glued to the magnetically permeable outer housing portion 106.

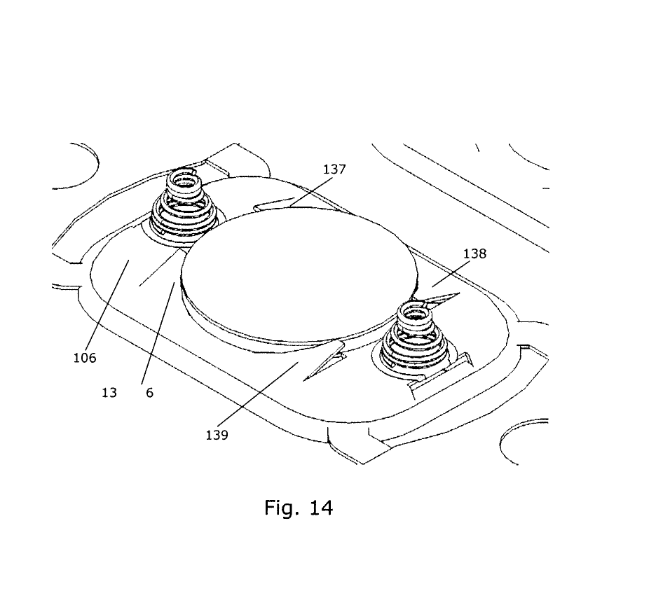

FIG. 14 shows an alternative implementation of the magnetically permeable outer housing portion 106. Instead of punched air flow passages 132, 133, 134, 135, air flow passages may be formed below angled hooks 136, 137, 138, 139. The hooks 136, 137, 138, 139 also contribute to correctly align the magnetic circuit relative to the magnetically permeable outer housing portion 106.

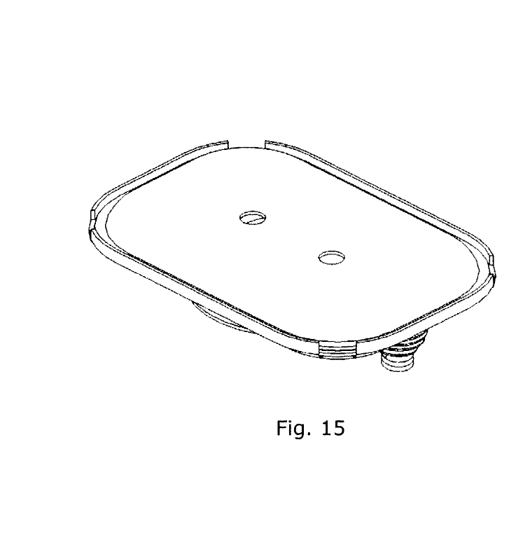

FIG. 15 shows an electro-acoustic transducer 200 which has been separated from frame 102, 103 by breaking struts 107, 108, 109, 110, shown in FIG. 1. However, prior to separating the electro-acoustic transducer 200 from frame 102, 103 the transducer may be tested by applying appropriate test signals to the spring elements 113, 114, which are shown in FIG. 2.

The description given with reference to FIGS. 1-15 relates, for simplicity reasons, only to assembling of a single electro-acoustic transducer 200. Obviously, since the assembling method according to the present invention is intended for use with automatic production lines a plurality of electro-acoustic transducers 200 can be assembled in parallel, i.e. simultaneously. Thus, when, for example, a voice coil 119 is provided as depicted in FIG. 4, voice coils are simultaneously provided to a plurality of components carriers. In addition, a plurality of electro-acoustic transducers 200 may be tested simultaneously by applying appropriate test signals to the spring elements 113, 114 of each of the electro-acoustic transducer prior to separating the transducers from frame 102, 103.

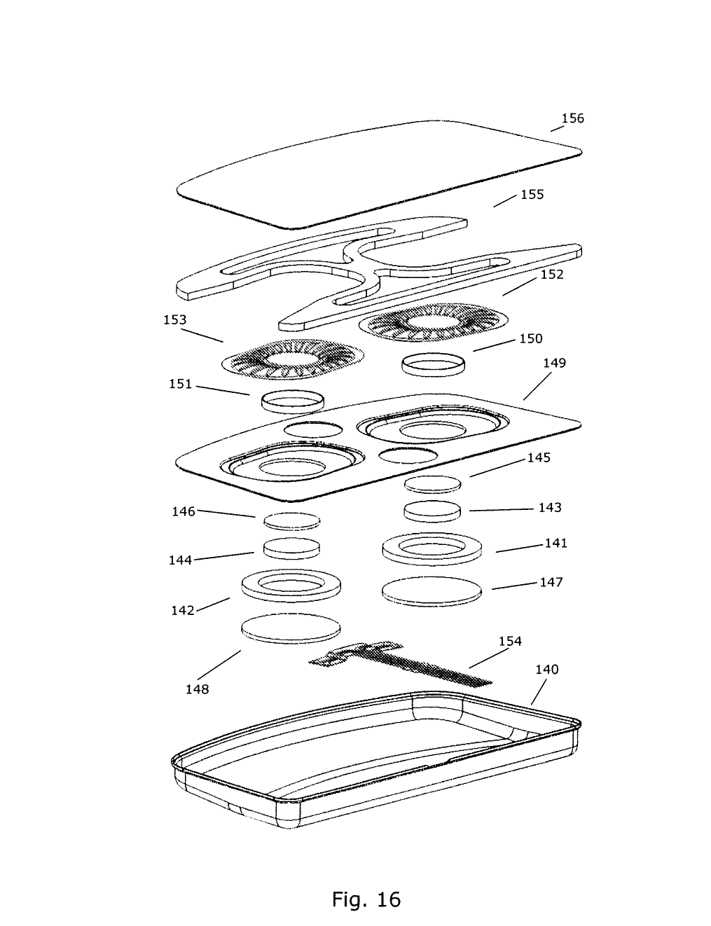

The assembling method according to the present invention is also applicable for assembling electro-acoustic transducers comprising a plurality, such as two, of transducer units. FIG. 16 shows an electro-acoustic transducer module 250 comprising two transducer units. The module depicted in FIG. 16 comprises a bottom cover 140, annular magnets 141, 142, centre magnets 143, 144, centre pole pieces 145, 146 and magnetically permeable yokes 147, 148. The annular magnets and the centre magnets are permanent magnets. Part of the magnetically permeable outer housing portion 149 forms outer pole pieces which, in combination with respective ones of centre pole pieces 145, 146, form air gaps adapted to receive respective ones of voice coils 150, 151. The voice coils 150, 151 are operatively connected to displaceable diaphragms 152, 153. When time varying electrical drive signals are passed through voice coils 150, 151 via connection element 154 diaphragms 152, 153 are displaced accordingly. A supporting frame 155 and a cover 156 are also depicted in FIG. 16.

As previously disclosed, the centre and/or annular magnets may comprise NdFeB compounds having a remanence flux density of at least 1.2 T, a coercive force of at least 1000 kA/m and an energy product of at least 300 kJ/m3. As an example, an NdFeB N44H may be applied. Similarly, the air gaps may have a width in the range of 0.5-0.8 mm, such as around 0.6 mm. The average magnetic flux density in the air gaps may be in the range of 0.3-1.5 T, such as in the range 0.5-1 T. Preferably, the voice coils are made of a wound copper wire or a wound CCA wire. In the case of a CCA wire, the copper content may be around 15%. Suitable pole piece materials comprise low carbon content steel materials such as, but not limited to, materials similar to Werkstoff-No. 1.0330 (St 2), 1.0333 (St 3), 1.0338 (St 4), all in accordance to DIN EN 10130.

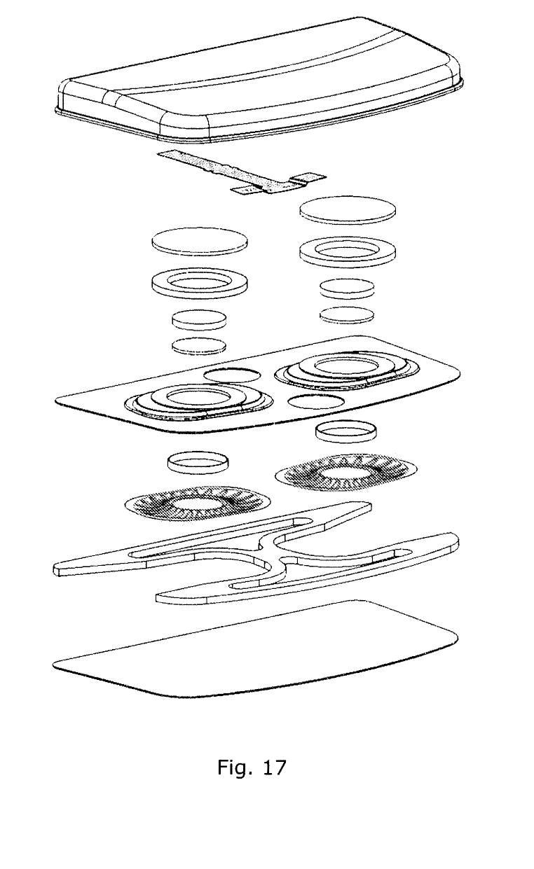

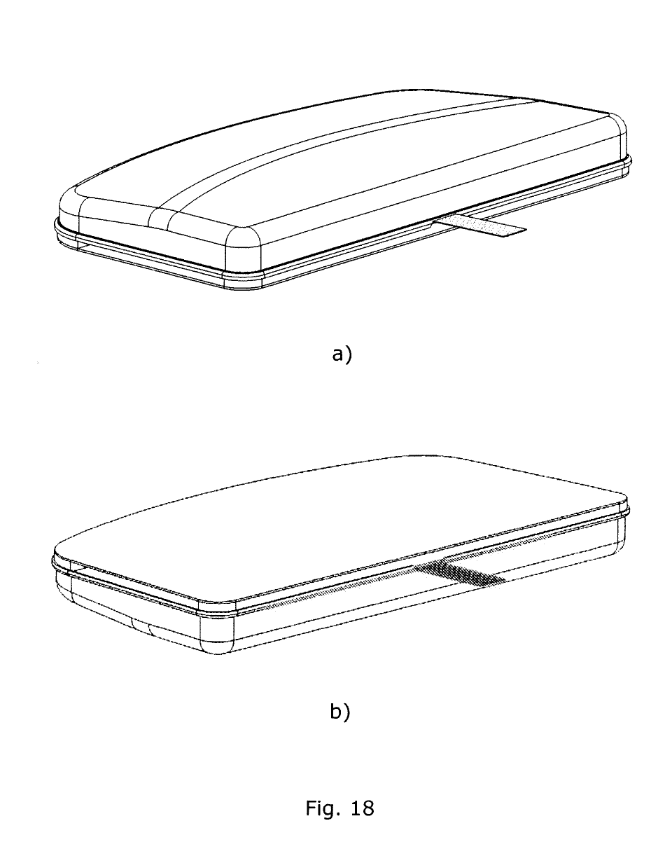

FIG. 17 shows a bottom of the transducer module 250 of FIG. 16 whereas FIG. 18 shows an assembled electro-acoustic transducer module.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A miniature electro-acoustic transducer comprising:
a magnetic circuit comprising a permanent magnet assembly adapted to generate a magnetic flux in an air gap, the permanent magnet assembly comprising first and second permanent magnets arranged on opposite sides of the air gap;
a magnetically permeable outer housing portion forming an integral part of the magnetic circuit; and
a voice coil positioned in the air gap, the voice coil being operatively connected to a diaphragm.

2. A miniature electro-acoustic transducer according to claim 1, wherein the magnetically permeable outer housing portion comprises an essentially planar structure extending in a plane being essentially parallel to a plane of extension of the diaphragm.

3. A miniature electro-acoustic transducer according to claim 2, wherein the magnetically permeable outer housing portion comprises an edge portion surrounding the essentially planar structure, the edge portion comprising a recess to which the diaphragm is adapted to be attached.

4. A miniature electro-acoustic transducer according to claim 2, wherein the essentially planar structure of the magnetically permeable outer housing portion forms an outer pole piece of the magnetic circuit.

5. A miniature electro-acoustic transducer according to claim 2, wherein the essentially planar structure of the magnetically permeable outer housing portion comprises an opening, and wherein an inner surface of said opening forms an outer boundary of the air gap.

6. A miniature electro-acoustic transducer according to claim 5, wherein the opening comprises an essentially circular opening.

7. A miniature electro-acoustic transducer according to any of the preceding claims, wherein the first permanent magnet comprises an annular permanent magnet, the annular permanent magnet having a first surface attached to the magnetically permeable outer housing portion.

8. A miniature electro-acoustic transducer according to claim 7, wherein the magnetic circuit comprises a magnetically permeable yoke attached to a second surface of the annular permanent magnet, said second surface being substantially parallel to the first surface of the annular permanent magnet.

9. A miniature electro-acoustic transducer according to claim 8, wherein the second permanent magnet comprises a centre magnet substantially concentrically arranged with the annular magnet, the centre magnet being arranged with a first surface attached to the magnetically permeable yoke.

10. A miniature electro-acoustic transducer according to claim 9, wherein the magnetic circuit comprises a magnetically permeable centre pole piece substantially concentrically arranged with the annular magnet, the centre pole piece being attached to a second surface of the centre magnet, the second surface of the centre magnet being substantially parallel to the first surface of the centre magnet.

11. A miniature electro-acoustic transducer according to claim 10, wherein an outer surface of the centre pole piece forms an inner boundary of the air gap.

12. A miniature electro-acoustic transducer according to claim 1, wherein one or more air flow passages are provided in the magnetically permeable outer housing portion, the one or more air flow passages allowing air trapped below the diaphragm to escape to the exterior of the transducer.

13. A miniature electro-acoustic transducer according to claim 1, further comprising a first and a second contact arrangement for providing a first and a second electrical connection from the exterior of the transducer to the interior of the transducer, each of the first and second contact arrangements comprising an electrically conducting resilient member and a U-shaped clamp.

14. A miniature electro-acoustic transducer according to claim 13, wherein the electrically conducting resilient member of each contact arrangement comprises a spring element.

15. A miniature electro-acoustic transducer according to claim 14, wherein each of the U-shaped clamps forms an exterior contact pad arranged to receive a spring element, and wherein each of the U-shaped clamps forms an interior contact pad arranged to receive a wire end from the voice coil.

16. A miniature electro-acoustic transducer according to claim 1, further comprising a cover having one or more sound outlet openings arranged therein, the cover being attached to the magnetically permeable outer housing portion so as to form a transducer housing in combination therewith.

17. A component carrier for a magnetically permeable outer part of a transducer housing of an electro-acoustic transducer, the component carrier comprising:
a magnetically permeable outer part of a transducer housing;
a frame supporting said magnetically permeable outer part, the frame having registration elements formed therein for registration of said component carrier with other component carriers; and
struts attaching the magnetically permeable outer part to the frame, said struts holding said magnetically permeable outer part in a substantially fixed position spaced apart from said frame.

18. A component carrier according to claim 17, wherein the magnetically permeable outer part comprises an essentially planar structure.

19. A component carrier according to claim 18, wherein the magnetically permeable outer part comprises an edge portion surrounding the essentially planar structure.

20. A component carrier according to claim 17, wherein the magnetically permeable outer part comprises an essentially circular opening adapted to receive a voice coil, and wherein an inner surface of said opening forms an outer boundary of an air gap in an assembled electro-acoustic transducer.

21. A component carrier according to claim 20, wherein the magnetically permeable outer part comprises one or more alignment members extending from the magnetically permeable outer part, said one or more alignment members being adapted to secure alignment of a permanent magnet assembly relative to the essentially circular though-going opening.

22. A component carrier according to claim 17, wherein one or more air flow passages are provided in the magnetically permeable outer part, the one or more air flow passages allowing air trapped below a diaphragm to escape to the exterior of an assembled electro-acoustic transducer.

23. A component carrier according to claim 17, wherein the magnetically permeable outer part is oriented in substantially the same plane as the frame.

24. A method of assembling an electro-acoustic transducer, the method comprising the steps of providing a component carrier, the component carrier comprising:
a magnetically permeable outer part of a transducer housing;
a frame supporting the magnetically permeable outer part, the frame having registration elements formed therein for registration of said component carrier with other component carriers; and
struts attaching the magnetically permeable outer part to the frame, said struts holding said magnetically permeable outer part in a substantially fixed position spaced apart from said frame.

25. A method according to claim 24, wherein the magnetically permeable outer part of the transducer housing comprises a first opening adapted to receive a voice coil, and second and third openings adapted to receive connection terminals.

26. A method according to claim 25, further comprising the step of positioning U-shaped connection elements in the second and third openings so that electrical connections are established through said openings, each of said U-shaped connection elements forming an interior and an exterior contact pad.

27. A method according to claim 26, wherein the U-shaped connection elements comprise a flex-print material.

28. A method according to claim 26, further comprising the step of attaching an electrically conducting resilient member to each of the exterior contact pads.

29. A method according to claim 26, further comprising the step of providing a voice coil in the first opening of the magnetically permeable outer part of the transducer housing, and connecting wire ends of the voice coil to the interior contact pads of the U-shaped connection elements.

30. A method according to claim 29, further comprising the step of providing a diaphragm, the diaphragm being attached to a recess of the magnetically permeable outer part of the transducer housing, the diaphragm further being attached to the voice coil.

31. A method according to claim 30, wherein the voice coil is attached to the diaphragm by gluing.

32. A method according to claim 30, further comprising the step of providing a cover, the cover being attached to the recess of the magnetically permeable outer part of the transducer housing, the cover having sound outlet openings arranged therein.

33. A method according to claim 32, further comprising the step of providing a permanent magnet assembly, the permanent magnet assembly being attached to the magnetically permeable outer part of the transducer housing.

34. A method according to claim 33, wherein the magnet assembly comprises an annular magnet and a centre magnet substantially concentrically arranged, the magnet assembly further comprising a centre pole piece arranged on the centre magnet and a yoke forming a magnetic return path between the annular and the centre magnet.

35. A method according to claim 33, wherein the permanent magnet assembly is attached to the magnetically permeable outer part of the transducer housing by gluing.

36. A method according to claim 33, wherein the magnetically permeable outer part of the transducer housing comprises one or more alignment members, said one or more alignment members extending from the magnetically permeable outer part and securing alignment of the permanent magnet assembly relative to the first though-going opening.

37. A method according to claim 35, further comprising the step of testing at least one assembled electro-acoustic transducer by providing one or more test signals to the electrically conducting resilient members.

38. A method according to claim 37, further comprising the step of releasing the assembled electro-acoustic transducer from the frame.
